(19) United States
(12) Patent Application Publication
(10) Pub. No.: US 2018/0226684 A1
(43) Pub. Date: Aug. 9, 2018

(54) ELECTROLYTE MODULATOR, FABRICATION METHODS AND APPLICATIONS OF SAME

(71) Applicants: University of California, Los Angeles, Los Angeles, CA (US); Ford Cheer International Limited, Road Town (VG)

(72) Inventors: Yunfeng Lu, Culver City, CA (US); Jianguo Xu, Walnut, CA (US); Fang Liu, Los Angeles, CA (US)

(21) Appl. No.: 15/888,232

(22) Filed: Feb. 5, 2018

Related U.S. Application Data
(60) Provisional application No. 62/455,752, filed on Feb. 7, 2017.
(60) Provisional application No. 62/455,800, filed on Feb. 7, 2017.

(51) Int. Cl. H01M 10/0567; H01M 10/0525; H01M 10/054; H01M 10/0569; H01M 10/0568; H01M 4/131; H01M 4/136; H01M 4/134; H01M 4/133; H01M 2/16

(52) U.S. Cl. CPC H01M 10/0567; H01M 10/0525; H01M 10/054; H01M 10/0569; H01M 10/0568; H01M 2300/0028; H01M 4/136; H01M 4/134; H01M 4/133; H01M 2/1653; H01M 2220/20; H01M 4/131

(57) ABSTRACT

An electrolyte modulator usable for a metal battery includes a liquid electrolyte; and a material of metal-organic frameworks (MOFs) incorporated in the liquid electrolyte to form a MOF slurry electrolyte. The MOFs are a class of crystalline porous solids constructed from metal cluster nodes and organic linkers and capable of bonding anions, eliminating ion pairs and boosting cation transport upon activation and impregnation of the liquid electrolyte.

### CROSS-REFERENCE TO RELATED PATENT APPLICATIONS

This application claims priority to and the benefit of, pursuant to 35 U.S.C. § 119(e), U.S. Provisional Patent Application Ser. Nos.62/455,752 and 62/455,800, both filed Feb. 7, 2017, which are incorporated herein in their entireties by reference.

### FIELD

This present invention relates generally to electrochemical technologies, and more particularly to an electrolyte modulator for metal batteries and fabrication methods of the same.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Development of rechargeable batteries has been under intensive investigations due to their ubiquitous applications in portable electronics. While developing next-generation battery systems with higher power capability, longer cycle life and superior safety is still challenging and demanding since these properties are desirable features in applications of power supplies for vehicles, such as hybrid electric vehicles (HEV), battery electric vehicles (BEV), plug-in HEVs, and extended-range electric vehicles (EREV). Furthermore, the driving-range anxiety for customers of electric vehicles require the battery packages with higher gravimetric and volumetric energy density, which are considerably restricted by current electrode and electrolyte electrochemistry.

For instance, the lithium metal anode, which possesses highest theoretical gravimetric capacity of 3860 mAh g⁻¹ and lowest SHE (standard hydrogen electrode) potential (−3.04 V vs H₂/H⁺), rendering the intriguing possibility of boosting overall energy density. However, it has been excluded from the secondary lithium battery systems due to its unrestricted consumption of electrolyte when directly exposing lithium to liquid electrolyte, therefore leading to poor Coulombic efficiency and severe safety issue. On the other hand, despite high conductivity of conventional liquid electrolyte, on the order of 10⁻² S/cm, it suffers from low cationic transference number (0.2-0.4) as well as parasitic reactions, which give rise to unsatisfactory power density and calendar battery life. The disadvantageous aspect of traditional liquid electrolyte has been persistently overlapped due to the lack of transforming additive to effectively modulate the ionic chemistry of existing electrolytes.

Therefore, a heretofore unaddressed need exists in the art to address the aforementioned deficiencies and inadequacies.

### SUMMARY

In one aspect, this invention relates to an electrolyte modulator usable for a metal battery. In one embodiment, the electrolyte modulator includes a liquid electrolyte; and a material of metal-organic frameworks (MOFs) incorporated in the liquid electrolyte to form a MOF slurry electrolyte. The MOFs are a class of crystalline porous solids constructed from metal cluster nodes and organic linkers and capable of bonding anions, eliminating ion pairs and boosting cation transport upon activation and impregnation of the liquid electrolyte.

In one embodiment, the MOFs have open metal sites (OMS) created by activating pristine MOFs to remove guest molecules or partial ligands thereof.

In one embodiment, each MOF contains metal centers from the p-block or the d-block, and one or more ligands of benzene-1,3,5-tricarboxylic acid (BTC), benzene-1,4-dicarboxylic acid (BDC), azobenzene-4,4′-dicarboxylic acid (ADC) and isonicotinic acid (IN).

In one embodiment, the MOFs comprise Cu₃(BTC)₂, Al₃O(OH)(BTC)₂, Fe₃O(OH)(BTC)₂, Mn₃(BDC)₃, (In₃O)(OH)(ADC)₂(IN)₂, or Zirconium-based MOF including UiO-66, UiO-67, UiO-66-NH₂, UiO-66-OH, or UiO-66-Br.

In one embodiment, the liquid electrolyte comprises one or more non-aqueous solvents and metal salts dissolved in the one or more non-aqueous solvents.

In one embodiment, the one or more non-aqueous solvents are selected to match the surface properties of the MOF material.

In one embodiment, the metal salts are selected to have anions with desired sizes, which depends, at least in part, upon the MOF material, wherein the anion sizes are selected to ensure that the salts to infiltrate into at least some of the pores of the MOFs, and then become immobilized therein to form the ionic conducting channels. In one embodiment, the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

In one embodiment, the metal salts comprise one or more of a lithium (Li) salt, a sodium (Na) salt, a magnesium (Mg) salt, and a zinc (Zn) salt. In one embodiment, the lithium salt includes lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, or a combination thereof.

In one embodiment, the sodium salt includes sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), or a combination thereof.

In one embodiment, the Mg salt includes magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), or a combination thereof.

In one embodiment, the Zn salt includes zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), or a combination thereof.

In one embodiment, a weight ratio of the MOFs to the liquid electrolyte ranges from about 10:1 to about 1:1000.

In another aspect, the invention relates to a battery. In one embodiment, the battery has the electrolyte modulator as disclosed above, a positive electrode, and a negative electrode. The electrolyte modulator comprises the MOF slurry electrolyte disposed between the positive electrode and the negative electrode.

In one embodiment, the battery is a lithium (Li) battery, a sodium (Na) battery, a magnesium (Mg) battery, or a zinc (Zn) battery.

In one embodiment, the positive electrode of the Li battery includes at least one of LiCoO₂ (LCO), LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide, lithium vanadium oxide (LiV₂O₅), Li₂MSiO₄ wherein M is composed of any ratio of Co, Fe, and/or Mn, and a material that undergoes lithium insertion and deinsertion.

In one embodiment, the positive electrode of the Na battery includes at least one of NaMnO₂, NaFePO₄, and Na₃V₂(PO₄)₃.

In one embodiment, the positive electrode of the Mg battery includes at least one of TiSe₂, MgFePO₄F, MgCo₂O₄, and V₂O₅.

In one embodiment, the positive electrode of the Zn battery includes at least one of γ-MnO₂, ZnMn₂O₄, and ZnMnO₂.

In one embodiment, the negative electrode of the Li battery includes at least one of Li metal, graphite, hard or soft carbon, graphene, carbon nanotubes, titanium oxide, silicon (Si), tin (Sn), germanium (Ge), silicon monoxide (SiO), silicon oxide (SiO₂), tin oxide (SnO₂), transition metal oxide, and a material that undergoes intercalation, conversion or alloying reactions with lithium.

In one embodiment, the negative electrodes of the Na, Mg and Zn batteries include Na metal, Mg metal, and Zn metal, respectively.

In one embodiment, some or all the electrode materials are combined with the MOF slurry electrolyte to achieve better ion transport throughout the electrode layers.

In one embodiment, the battery further includes at least one electron blocking separator membrane disposed in the the MOF slurry electrolyte between the between the positive electrode and the negative electrode.

In one embodiment, the at least one electron blocking separator membrane is either ionic conductive or non-conductive. In one embodiment, the at least one electron blocking separator membrane comprises poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, copolymers thereof, perovskite lithium lanthanum titanate Li₃ₓLa_{2/3-x)}M_{(1/3)-x}TiO₃, wherein 0<x<0.16, and M=Mg, Al, Mn, Ru, or the like, lithium phosphorous oxynitride (LiPON, Li_{3.5}PO₃N₀₀₅), garnet oxide including Li₅La₃M₂O₁₂, wherein M=Nb, Ta, or Zr, lithium sulphide, or combinations thereof.

In yet another aspect, the invention relates to a method for making an electrolyte modulator for a battery. In one embodiment, the method includes incorporating a material of metal-organic frameworks (MOFs) into a liquid electrolyte to form a MOF slurry electrolyte, the MOFs being a class of crystalline porous solids constructed from metal cluster nodes and organic linkers and being capable of bonding anions, eliminating ion pairs and boosting cation transport upon activation and impregnation of the liquid electrolyte.

In one embodiment, the method further includes comprising synthesizing the MOF material based on a facile hydrothermal method, or without a water modulator.

In one embodiment, the method also includes creating open metal sites (OMS) of the MOFs by activating pristine MOFs to remove guest molecules or partial ligands thereof.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1A shows a scheme of a metal organic framework (MOF) material HKUST-1, made from copper and benzene tricarboxylic acid (BTC) ligands, which forms a rigid framework with 1.1 nm pore diameters, according to one embodiment of the invention.

FIG. 1B shows a schematic, perspective view of the HKUST-1 framework with ionic channels and solvated ions within the ionic channels, according to one embodiment of the invention.

FIG. 1C shows a cross view of the HKUST-1 framework with the ionic channels showing the binding of ClO₄⁻¹ to the open copper sites and the free, solvated Li⁺ions within the ionic channels, according to one embodiment of the invention.

FIG. 2 shows a battery having an electrolyte structure using MOFs as an electrolyte modulator, according to one embodiment of the invention.

FIG. 3 shows X-ray diffraction patterns (XRD) of as-synthesized UiO-66-NH₂, according to one embodiment of the invention.

FIG. 4 shows scanning electron spectroscopy (SEM) of as-synthesized UiO-66-NH₂, according to one embodiment of the invention.

FIG. 5 shows thermogravimetric analysis (TGA) of as-synthesized UiO-66-NH₂, according to one embodiment of the invention.

FIG. 6 shows N₂ adsorption/desorption isotherms of as-synthesized UiO-66-NH₂, according to one embodiment of the invention.

FIG. 7 shows ionic conductivity (Log (S cm⁻¹) versus reciprocal temperature (1/K) of UiO-66-NH₂ electrolyte (Arrhenius plots), according to one embodiment of the invention.

FIG. 8 shows the Li transference number measurements for UiO-66-NH₂ slurry electrolyte through a combination of alternating current (AC) impedance measurements (inset) and potentiostatic polarizations, according to one embodiment of the invention.

FIG. 9 shows comparison of liquid electrolyte with UiO-66-NH₂ slurry electrolyte in Li symmetric cell tests under 0.13 mA cm⁻² for first 100 hours and 0.26 mA cm⁻² for the subsequent cycles, according to one embodiment of the invention.

FIG. 10 shows comparison of liquid electrolyte with UiO-66-NH₂ slurry electrolyte in Li|LiFePO₄ half-cell tests under 1 C current density, according to one embodiment of the invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more”. The word “exemplary” is used herein to mean “serving as an example, instance, or illustration”. Any aspect described herein as “exemplary” is not necessarily to be construed as preferred or advantageous over other aspects. Unless specifically stated otherwise, the term “some” refers to one or more. Combinations such as “at least one of A, B, or C”, “one or more of A, B, or C”, “at least one of A, B, and C”, “one or more of A, B, and C”, and “A, B, C, or any combination thereof” include any combination of A, B, and/or C, and may include multiples of A, multiples of B, or multiples of C. Specifically, combinations such as “at least one of A, B, or C”, “one or more of A, B, or C”, “at least one of A, B, and C”, “one or more of A, B, and C”, and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module”, “mechanism”, “element”, “device” and the like may not be a substitute for the word “means”. As such, no claim element is to be construed as a means plus function unless the element is expressly recited using the phrase “means for”. It should also be understood that one or more steps within a method may be executed in different order (or concurrently) without altering the principles of the invention.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The description is now made as to the embodiments of the invention in conjunction with the accompanying drawings. Various modifications to these aspects will be readily apparent to those skilled in the art, and the generic principles defined herein may be applied to other aspects. In accordance with the purposes of this invention, as embodied and broadly described herein, this invention relates to an electrolyte modulator for metal batteries and fabrication methods of the same.

According to the invention, the electrolyte modulator includes a liquid electrolyte that includes metal salts, and solvents and metal-organic frameworks (MOFs), which is usable for electrochemical cells such as metal batteries. The MOFs are capable of bonding anion, eliminating ion pairs and boosting cation transport upon activation and impregnation of liquid electrolyte. The MOFs are a class of crystalline porous solids constructed from metal cluster nodes and organic linkers, and the MOF solids function as electrolyte modulators to enhance cationic transference number, alleviate interfacial resistance and mitigate safety issues.

In the certain embodiments, the electrolyte modulator having ion/ionic-channels are formed from biomimetic metal-organic frameworks (MOFs). The open metal sites (OMS) of the MOFs are created by activating pristine MOFs to remove guest molecules or partial ligands. Through introducing (impregnating) binary liquid electrolyte, the polarized OMS is capable of bonding anion and thus forming anion-decorated ion channels. The resulting solid-like or semi-solid electrolyte structure is considered as a negatively charged framework, which facilitates relative fast movements of cations within the channels. If the electrolyte structure were flooded with liquid electrolyte, it is regarded as a gel electrolyte. If liquid electrolyte dominates (MOF: liquid electrolyte <0.5 mg/ul) the whole electrolyte structure, the MOFs are considered as electrolyte additive.

In the certain embodiments, the electrolyte structure is formed by spontaneously binding electrolyte anions (e.g., ClO₄⁻, BF₄-, PF₆⁻, TFSI⁻ (bis(trifluoromethane)sulfonimide), FSI⁻ (bis(fluorosulfonyl)imide), etc.) to the OMS of the MOF scaffolds. The binding constructs negatively charged channels in the pores of the MOF scaffold, which enables fast conduction of solvated ions (e.g., Li⁺, Na⁺, Mg²⁺, Zn²⁺).

For lithium-based batteries, the positive electrode is formed of LiCoO₂ (LCO) and the negative electrode is formed of lithium metal (Li). Other examples of suitable positive electrodes include LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide (e.g., LiNi_{0.8}Co_{0.05}Al_{0.05}O₂ or NCA), lithium vanadium oxide (LiV₂O₅), Li₂MSiO₄ (M is composed of any ratio of Co, Fe, and/or Mn), or any other suitable material that can sufficiently undergo lithium insertion and deinsertion. Other examples of suitable negative electrodes include graphite, hard or soft carbon, graphene, carbon nanotubes, titanium oxide (Li₄Ti₅O₁₂, TiO₂), silicon (Si), tin (Sn), Germanium (Ge), silicon monoxide (SiO), silicon oxide (SiO₂), tin oxide (SnO₂), transition metal oxide (Fe₂O₃, Fe₃O₄, Co₃O₄, MnₓO_{y}, etc), or any other suitable material that can undergo intercalation, conversion or alloying reactions with lithium.

For sodium, magnesium, or zinc metal batteries, suitable negative electrodes for sodium, magnesium, or zinc metal batteries include, respectively, sodium metal, magnesium metal, or zinc metal. Suitable positive electrodes for sodium metal batteries include NaMnO₂, NaFePO₄, and/or Na₃V₂(PO₄)₃. Suitable positive electrodes for magnesium metal batteries include TiSe₂, MgFePO₄F, MgCo₂O₄, and/or V₂O₅. Suitable positive electrodes for zinc metal batteries include γ-MnO₂, ZnMn₂O₄, and/or ZnMnO₂. Some or all the electrode materials can be combined with MOF electrolyte in order to achieve better ion transport throughout the electrode layers.

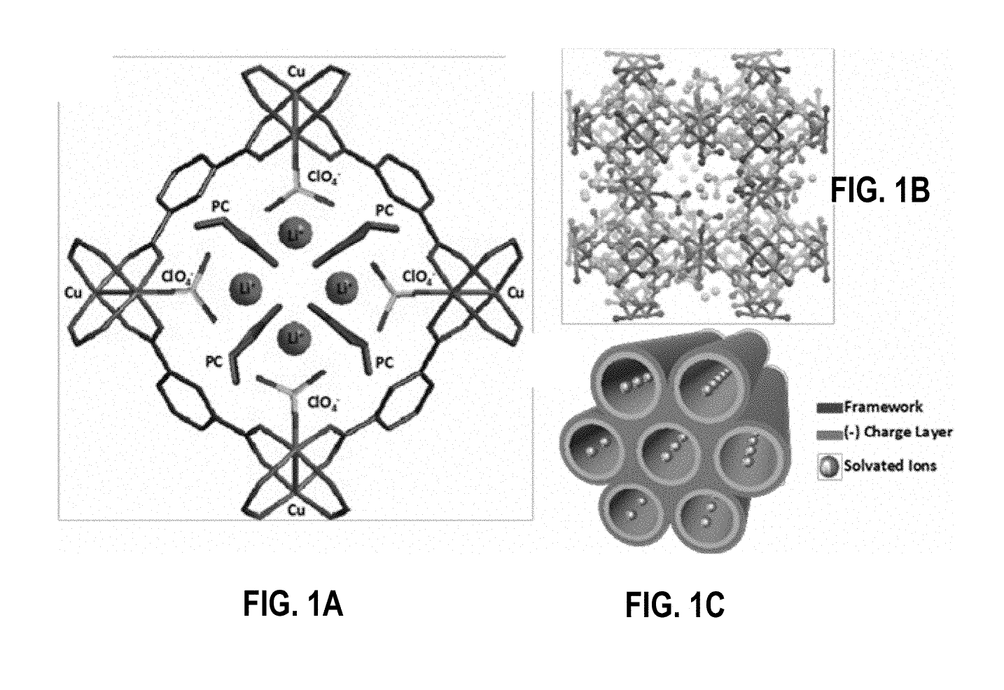

Metal organic frameworks (MOFs) are a class of crystalline porous solids constructed from metal cluster nodes and organic linkers. The synthetic procedures of MOF typically involve hydrothermal method, as-prepared MOF pore channels are usually occupied by guest species (e.g. solvent molecules, like water or dimethylformamide). The removal of solvent species by activation creates vacant spaces to accommodate guest binary electrolyte. The colossal candidates of MOF are of particular interest due to their various metal centers, ligand derivatives and corresponding topology. As exemplified by HKUST-1 (i.e., an MOF), which constructed from Cu (II) paddle wheels and 1,3, 5-benzenetricarboxylates (BTC) linkers. More specifically, FIGS. 1A-1C illustrates a 2-dimensional unit cell of HKUST-1, where HKUST-1 possesses three-dimensional pore channels with a pore diameter of 1.1 nm. The three spheres represent the various pore sizes within the framework of the unit cell.

Table 1 lists examples of the MOFs that are used as the channel scaffolds with pore size ranging from 1.1 nm to 2.9 nm, containing metal centers from the p-block (Al and In) and from the d-block (Cu, Fe, and Mn), as well as different ligands (BTC, benzene-1,4-dicarboxylic acid (BDC), isonicotinic acid (IN), and azobenzene-4,4′-dicarboxylic acid (ADC)).

TABLE 1
Examples of the MOFs.

| MOFs | Formula | Ligand structure | Pore size |
|---|---|---|---|
| HKUST-1 Mil-100-Al Mil-100-Fe | Cu₃(BTC)₂ Al₃O(OH)(BTC)₂ Fe₃O(OH)BTC)₂ | BTC benzene-1,3,5-tricarboxylic acid 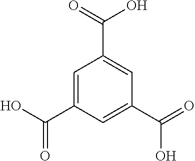 [SMILES: O=C(O)c1cc(C(=O)O)cc(C(=O)O)c1] | 1.1 nm 2.9 nm 2.9 nm |
| MOF-73 | Mn₃(BDC)₃ | BDC benzene-1,4-dicarboxylic acid 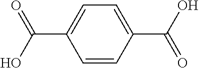 [SMILES: O=C(O)c1ccc(C(=O)O)cc1] | 1.1 nm |
| In-MOF | (In₃O)(OH)(ADC)₂(IN)₂ | ADC azobenzene-4,4′-dicarboxylic acid 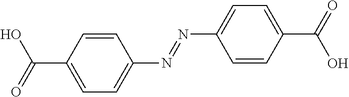 [SMILES: O=C(O)c1ccc(/N=N/c2ccc(C(=O)O)cc2)cc1] | 2.3 nm |
| | | IN isonicotinic acid 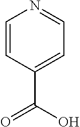 | |

In certain embodiments, the MOF material selection is also based on the stability of the MOFs in the battery electrochemical environment. The judicious selection of the metal centers and organic linkers (ligands) affords the synthesis of over 20,000 MOFs with designable functionalities and pore channels. In certain embodiments, MOFs with mesopore structures are synthesized by using a large ligand. In one embodiment, the MOF with a mesopore structure is the mesoprous In-MOF. In certain embodiments, MOFs with more surface functional groups for coordinating liquid electrolytes are also used. In certain embodiments, other examples of suitable MOF materials include, but are not limited to, Mil-100 such as Mil-100-Al and Mil-100-Fe in listed Table 1, mesoprous In-MOF, and the like. It should be appreciated that any MOF can be used to practice this invention.

In certain embodiments, the MOFs are synthesized in the presence of a solvent (e.g., water) and the ligands, both of which coordinate with the MOF's metal centers. Removal of the solvent molecules (e.g., at an elevated temperature under vacuum) breaks the solvent coordination from the MOFs, resulting in MOF scaffolds with unsaturated metal centers. The conditions for solvent molecule removal include a temperature ranging from about 200° C. to about 220° C. at a pressure of about 30 mTorr. This temperature range is suitable for removing any solvent, although it is to be understood that high boiling point solvent may require longer evacuation times than low boiling point solvents. In an example, the powder form MOF material is degassed or activated under vacuum at a high/elevated temperature (e.g., from about 200° C. to about 220° C.) to remove absorbed water molecules. It should be appreciated that other solvent molecule removal methods may also be used in the invention.

Table 2 shows another serial example of MOFs. UiO-66 stands for Zirconium MOF with perfect stoichiometry of [Zr₆O₄OH₄][C₆H₄(COO)₂]₆. Its typical synthetic route is hydrothermal reactions between ZrCl₄ with terephthalic acid (BDC) in a polar (hydrophilic) aprotic solvent of dimethylformamide (DMF). Zr⁴⁺ is gradually hydrolyzed to form a six-center octahedral metal cluster with the assistance from basicity of DMF. The faces of metal cluster octahedron are capped with eight oxygens, of which four are protonated to balance the charge. The cationic Zr₆O₄OH₄ are bridged by terephthalate, the resulting three-dimensional frameworks possess tetrahedral and octahedral microporous cages of 7.5 to 12 Å. Another isostructural material UiO-67 can be obtained by replacing the terephthalic acid (BDC) with longer linker of 4,4′-biphenyldicarboxylic acid (BPDC). The consequent pore size expands from 7.5 and 12 Å to 12 and 16 Å, respectively. Both UiO-66 and UiO-67 share almost identical Zirconium metal octahedron, it undergoes a dehydration by removal of two water molecules from the cages, thus creating partially open metal sites as well as local polarized framework surface.

Several derivatives of these MOFs have been synthesized with linker possessing functional groups such as amines, halogens, hydroxyls or nitros, as enclosed herein at Table 2. The vast diversity of functional side groups is believed to introduce desirable properties for the MOF as solid electrolyte, like higher ionic conductivity, higher transference number and superior stability against reactive alkali metals. For instance, electron donor/acceptor properties of side groups would impact the acidity of benzene carboxylate, thus shift the charge balance of overall metal organic framework and resulting anion adsorption capability. In addition, self-sacrificial decomposition of nitrogen or halogen containing groups from MOF ligand in contact with lithium would generate solid-state interface (SEI) comprising lithium nitrate or lithium halogen, which are well known to be good lithium conductor and protector of lithium from continuous consumptive reaction with liquid electrolyte.

TABLE 2
Examples of MOFs

| Zirconium-based | | |
|---|---|---|
| MOF | Ligand | |
| UiO-66 | Terephthalic acid (BDC) | 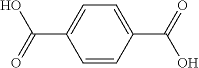 [SMILES: O=C(O)c1ccc(C(=O)O)cc1] |
| UiO-67 | 4,4′-biphenyldicarboxylic acid (BPDC) | 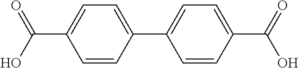 [SMILES: O=C(O)c1ccc(-c2ccc(C(=O)O)cc2)cc1] |
| UiO-66-NH₂ | 2-Aminoterephthalic acid (NH₂—BDC) | 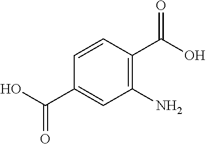 [SMILES: Nc1cc(C(=O)O)ccc1C(=O)O] |
| UiO-66-NO₂ | 2-nitroterephthalic acid (NO₂—BDC) | 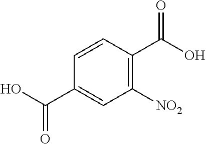 [SMILES: O=C(O)c1ccc(C(=O)O)c([N+](=O)[O-])c1] |
| UiO-66-OH | 2-Hydroxyterephthalic acid (OH—BDC) | 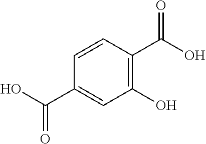 [SMILES: O=C(O)c1ccc(C(=O)O)c(O)c1] |
| UiO-66-Br | 2-Bromoterephthalic acid (Br—BDC) | 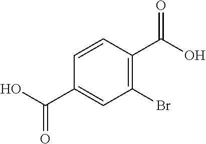 [SMILES: O=C(O)c1ccc(C(=O)O)c(Br)c1] |

During synthesis of the MOFs, surface defects are created. The surface defects of the MOF material are similar to pores in that they expose more unsaturated metal centers to coordinate salt anions. Therefore, the pores inside of the MOF material, as well as the defects resulting from the packing of the MOF materials, can become ion transportation channels. As for UiO-66 series MOFs, metal vs ligand ratio, synthetic temperature, hydrochloric acid as well as incorporation of mono/di-carboxylic acid were manipulated to tune the MOF defects sites. For instance, trifluoroacetic acid, trichloroactic acid, formic acid, acetic acid, pivalic acid, benzoic acid, and stearic acid, etc. are effective in creating massive missing ligands by replacement of terephthalic acid and decomposition upon activation, thus resulting MOFs possess defective structure and abundant sites for coordinating anions. These defects throughout the frameworks are also classified as immobilization sites for anion and transport facilitator for cations.

The activated MOF material powder is combined with, and is soaked in, a non-aqueous liquid electrolyte composed of metal salt(s) dissolved in non-aqueous solvent(s). The non-aqueous liquid electrolyte solvent(s) are ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, or an ionic liquid, chain ether compounds such as gamma butyrolactone, gamma valerolactone, 1,2-dimethoxyethane, and diethyl ether, cyclic ether compounds such as tetrahydrofuran, 2-methyltetrahydrofuran, 1,3-dioxolane, and dioxane, and mixtures of two or more of these solvents. The polarity of the non-aqueous solvent(s) is selected to match the surface properties of the MOF material.

The metal salt dissolved in the liquid electrolyte solvent is a lithium (Li) salt, a sodium (Na) salt, a magnesium (Mg) salt, and/or a zinc (Zn) salt. Examples of suitable lithium salts include lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, and combinations thereof. Examples of suitable sodium salts include sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), and the like. Examples of suitable Mg salts include magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), and the like. Examples of suitable Zn salts include zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), and the like. The metal salt is selected to have a suitably sized anion, which depends, at least in part, upon the MOF material that is used. The anion size is selected to ensure that the salt can infiltrate into at least some of the MOF pores, and then become immobilized therein to form the ionic conducting channel.

The activated MOF material powder is combined with the liquid electrolyte in a weight ratio ranging from about 10:1 to about 1:1000. The uniformity of combined electrolyte can be achieved by heating, stirring, evacuating, sonicating or aging. The MOF material is soaked in the liquid electrolyte for around one week, at room temperature. Soaking the degassed or activated MOFs in liquid electrolyte (e.g., LiClO₄ in propylene carbonate (PC)) allows the anions (e.g., ClO₄) of the metal salt to bind to the unsaturated metal sites of the MOF and spontaneously form anion-bound MOF channels. In other words, the anions are bound to metal atoms of the MOF such that the anions are positioned within the pores of the MOF. After formation, the negatively charged MOF channels are ion transport channels that allow for effective transport of the solvated cations (e.g., PC-solvated Li⁺ or Na⁺ or Zn²⁺ or Mg²⁺). The solvated cations may hop through and/or between the plurality of negatively charged MOF channels. More particularly, the solvated cations can transfer within and/or between the channels by hopping among each of the anions and/or solvents. In the pores, composed by the MOF units, the cations transfer with the help of the solvent.

In certain embodiments, when incorporating MOFs into a liquid electrolyte, the resulting slurry-like electrolyte has the MOFs homogenously dispersed therethough (denoted as an MOF slurry electrolyte). In certain embodiments, the MOF type, particle sizes, crystallinity, defects, activation conditions and solid over liquid ratio, etc. are tuned during the synthetic and activation procedure in order to achieve desirable viscosity, thermal shrinkage, pore sizes, conductivity or other properties of the resulting slurry electrolyte. In certain embodiments, the MOF slurry electrolyte as an electrolyte can be incorporated into the battery packages similar like a conventional electrolyte. For example, in one embodiment, the MOF slurry electrolyte can be injected into the battery packages after lamination of electrodes/separator sheets. Another alternative ways are by coatings via blade, spraying or dipping directly either on electrodes or separators. It should be appreciated to one skilled in the art that other incorporation methods that help uniformly disperse the MOF slurry electrolyte into the battery may also apply according to the invention.

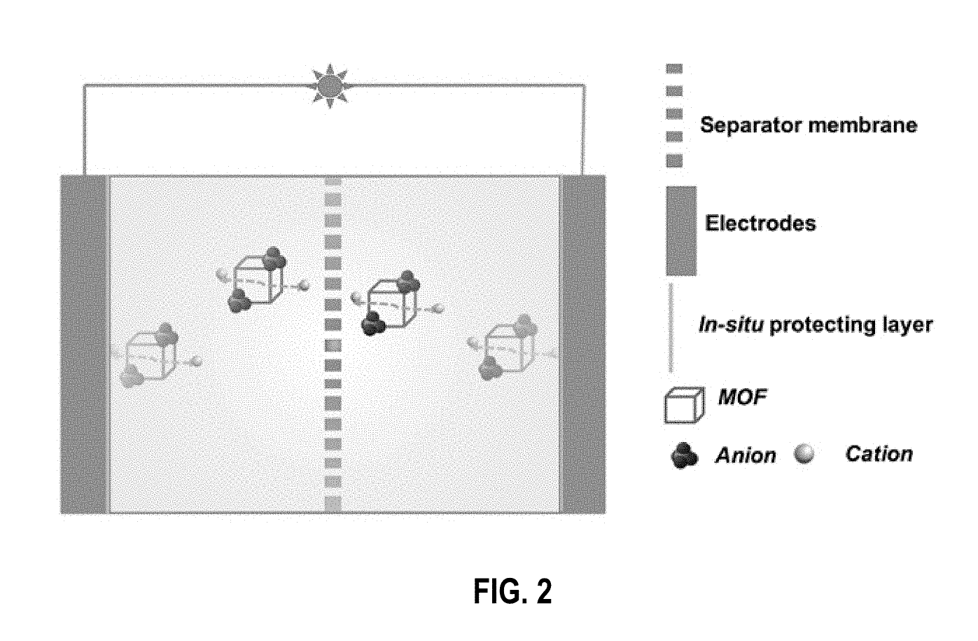

As shown in FIG. 2, a battery comprising the MOF slurry electrolyte as an electrolyte is shown according to one embodiment of the invention. the battery is a lithium (Li) battery, a sodium (Na) battery, a magnesium (Mg) battery, or a zinc (Zn) battery. The MOF slurry electrolyte includes a plurality of activated MOFs. The battery also has a positive electrode, and a negative electrode. The electrolyte modulator comprising the MOF slurry electrolyte is disposed between the positive electrode and the negative electrode. Further, each of the positive electrode and the negative electrode may have an in-situ protecting layer formed thereon facing the MOF slurry electrolyte.

In addition, the battery may also have one or more electron blocking separator membranes disposed in the the MOF slurry electrolyte between the between the positive electrode and the negative electrode. In this exemplary embodiment as shown in FIG. 2, the battery includes only one electron blocking separator membrane. The electron blocking separator membranes are either ionic conductive (e.g., any gel forming polymer electrolytes or solid electrolytes) or non-conductive. In certain embodiments, the electron blocking separator membranes are selected from poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, copolymers thereof, perovskite lithium lanthanum titanate Li₃ₓLa_{(2/3-x)}M_{(1/3)-2x}TiO₃ (LLTO, where 0<x<0.16, and M=Mg, Al, Mn, Ru, or the like), lithium phosphorous oxynitride (LiPON, Li_{3.5}PO₃N_{0.5}), garnet oxide (Li₅La₃M₂O₁₂, where M=Nb, Ta, or Zr; e.g., cubic LLZO: Li₇La₃Zr₂O₁₂), lithium sulphide, and combinations thereof.

According to the invention, the foregoing MOF porous solids serve as an electrolyte modulator, transforming ionic chemistry of electrolyte by immobilizing anion and facilitating cation transport. The polarization induced by anion movements is reduced and the resulting modified electrolyte is projected to benefit from following advantages:

1) As for rechargeable lithium batteries, the restricted movements of anions give rise to the enhanced cation transference number and therefore the improved power capability. 2) Parasitic reactions involving anions are mitigated, thereby postulating the prolonged cycle life. The MOF electrolyte modulator can also be applied to lithium metal batteries.

3) Incorporation of the solid MOFs helps with mechanical and thermal stability.

4) Alleviated interfacial resistance either from self-healing decomposition of ligands or from tunable surface area/particle size of the MOFs assists in eliminating metallic dendrites.

Without intent to limit the scope of the invention, examples and their related results according to the embodiments of the present invention are given below. These examples, however, should not in any sense be interpreted as limiting the scope of the present invention.

### EXAMPLE 1

In this exemplary embodiment, the crystallized UiO-66-NH₂ was synthesized based on a facile hydrothermal method. Firstly, about 5 mmol 2-amino-terephthalic acid (NH₂-BDC), about 3 mmol ZrCl₄ and about 6 mmol H₂O were added into about 150 mL dimethylformamide (DMF) for 30 minutes continuously stirring. The excessive ligand ratios over a metal salt and two equivalent molars of water were intended for modulating the growth Zr cluster nodes as well as obtaining highly crystalline products, especially for UiO-66-NH₂. The transparent mixture after fully dissolution was transferred into a 250 mL glass bottle at pre-heated about 120° C. for about 21 hours. The pale yellow precipitates were collected via centrifugation and thoroughly washed with DMF (3 times) and methanol (3 times).

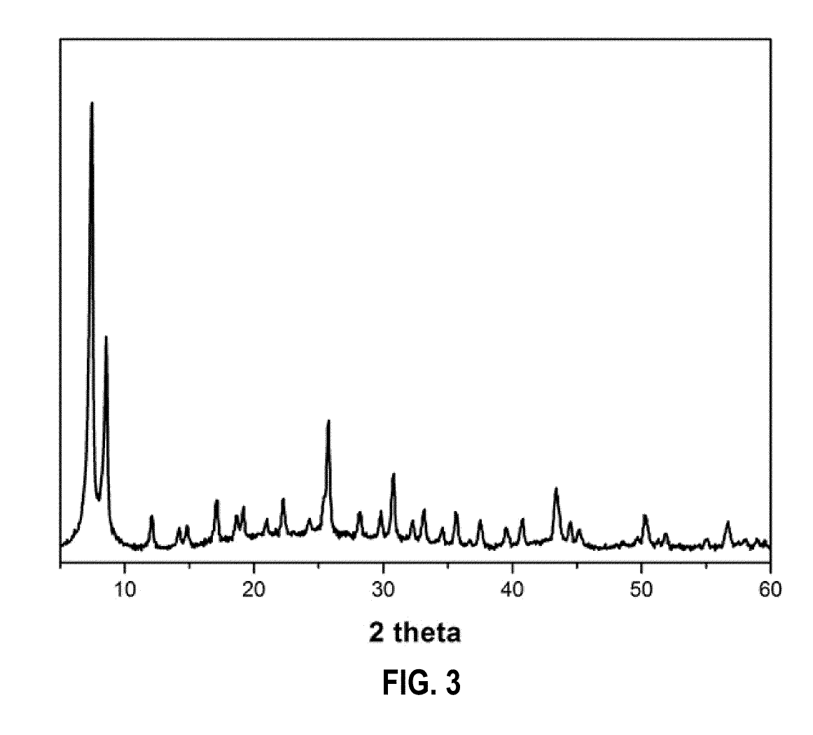

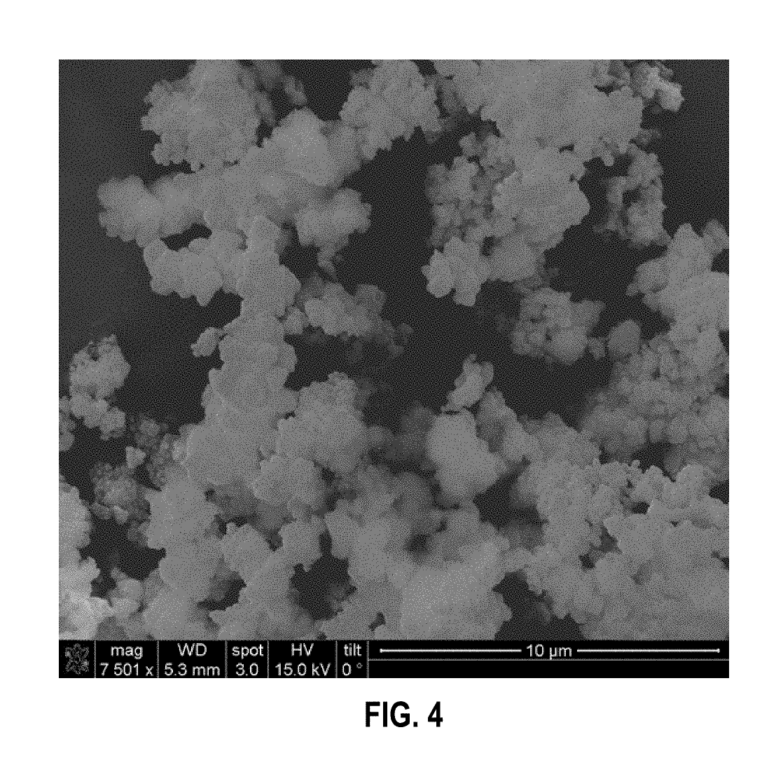

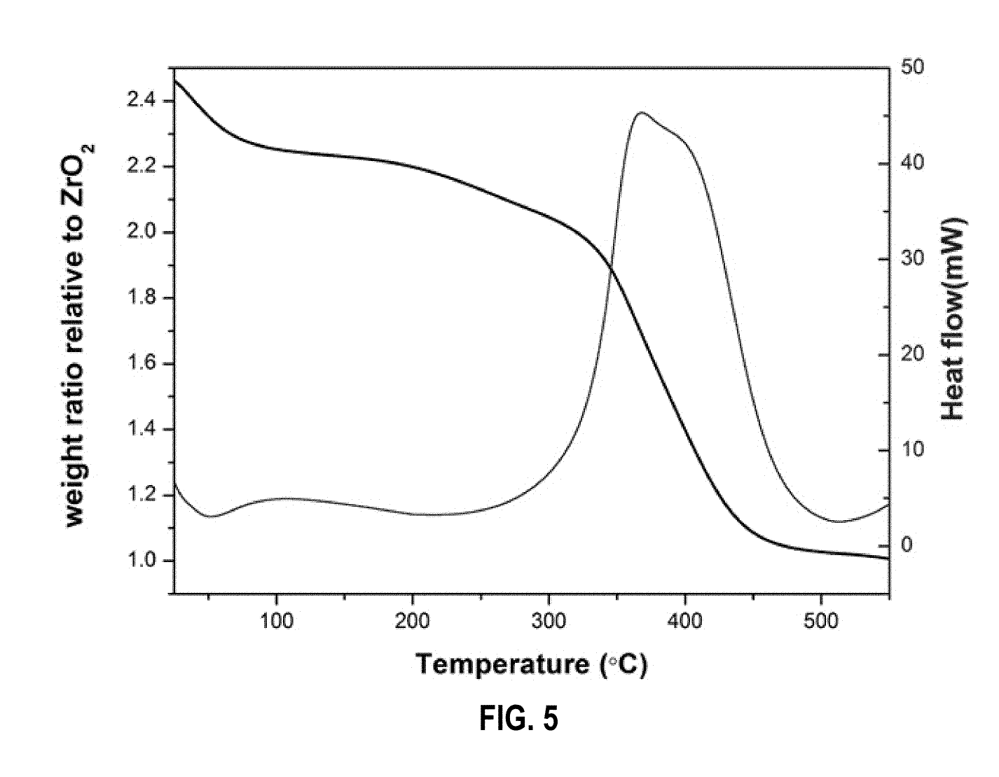

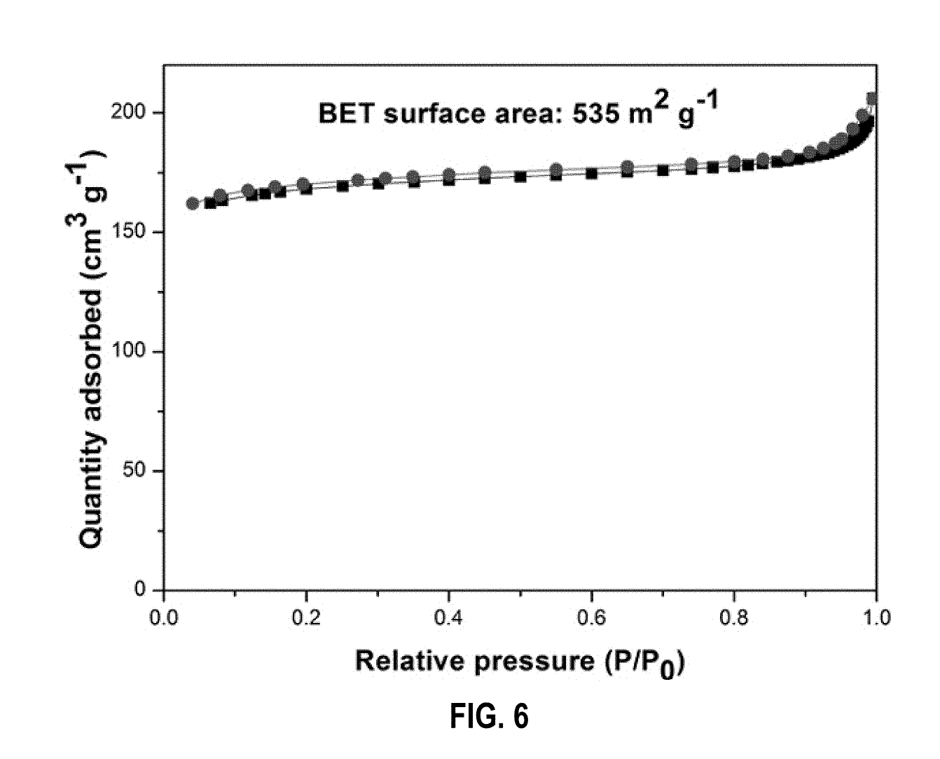

As shown in FIG. 3, the crystal structure was determined by X-ray diffraction patterns, all peaks were indexable to simulated patterns for UiO-66-NH₂ and no impurities were detected. The morphology and particle size were examined by scanning electron spectroscopy (SEM), as shown in FIG. 4, the products include microsized aggregates of intergrown crystals. Thermogravimetric analysis (TGA) was performed to analyze the thermal property as shown in FIG. 5. The weight shows three stepwise drops along with a temperature ramping rate of about 5° C. min⁻¹ in the air atmosphere. The first and second weight loss in the range of about 25-80° C. and about 80-230° C. can be explained by removing pore-trapped solvent molecular and deprotonation of UiO -66-NH₂ from Zr₆O₄(OH)₄(NH₂-BDC)₆ to Zr₆O₆(NH₂-BDC)₆, respectively. The subsequent drop is due to decomposition of the ligand and the residual was identified to be monoclinic ZrO₆. The mass ratio of the ligand from TGA mass loss value compared with calculation from perfect stoichiometry UiO-66-NH₂ demonstrate that there are defective structure and missing linker in the MOFs. Those defects might also act as adsorption sites for anion and create more open metal sites. The texture property of porous MOF solids was evaluated by N₂ adsorption/desorption isotherms. Before surface area measurement, the porous powders undergo a heat treatment at about 180° C. for about 12 hours under pressure of about 20 um Hg. As shown in FIG. 6, the Brunauer-Emmett-Teller (BET) surface area is calculated to be about 535 cm² g⁻¹ and the majority pores are micropores as indicated by dominate adsorption at low relative pressure. It is worthy to note that, the crystallinity, particle size, surface area and defects of the MOFs can further be tuned by a variety of synthetic strategies, like using more water or other acid modulator, hydrochloric acid, acetic acid, trifluoroacetic acid, stearic acid, etc.

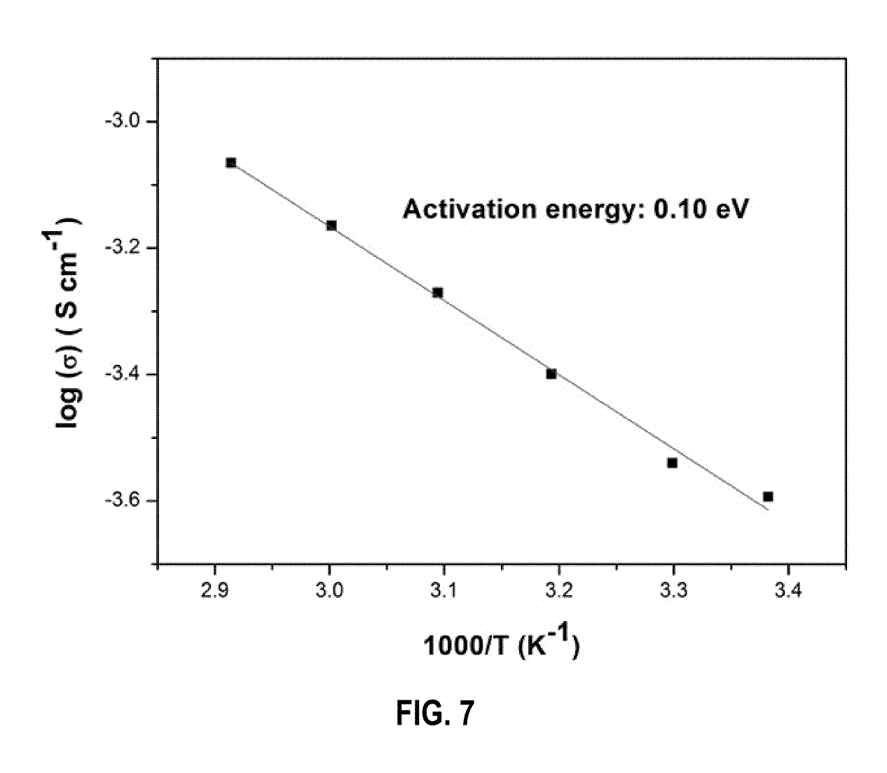

The ionic conductivity was measured based on the alternating circuit (AC) impedance method. The MOFs were initially activated at about 180° C. for about 24 hours under vacuum and further soaked in about 1M of LiClO4|PC (with about 5wt % fluoroethylene carbonate, FEC) electrolyte for about another 24 hours. Semi-solid MOF powders were collected after filtering till no observation of visible liquid flows. Afterwards, a dense pellet was prepared in an evacuable pellet die mode with area (A) of about 1.32 cm². Along with applying pressure of about 300 Mega Pasical, the extrusion of interparticle-reserved liquid electrolyte was observed and the dense pellet was completely wiped off by tissues to guarantee no ionic conductivity contribution from the surface liquid electrolyte. The as-prepared pellets were sandwiched between two stainless steel plates and assembled into CR2032-type coin cells for AC impedance measurements. The Nyquist plot includes a semi-circle in high-frequency region and a spike in the low-frequency region, which correspond to resistances from bulk/grain boundary and blocking electrode, respectively. Ionic resistance (R) was determined based on the intersect point of the semi-circle and the spike. The resulting ionic conductivity presented herein at is from a combination of bulk and boundary resistance. The equation of calculation is d=(1/R)*(L/A), where L is pellet thickness. Super ionic conductivity of about 2.55×10⁴ S cm⁻¹ were obtained at room temperature, and the activation energy is calculated to be about 0.1 eV as shown in the Arrhenius plot (FIG. 7), suggesting potential devices application in wide-temperature

### EXAMPLE 2

In this exemplary embodiment, the amorphous UiO-66-NH₂ was synthesized without a water modulator. Firstly, about 5 mmol NH₂-BDC and about 3 mmol ZrCl₄ were fully dissolved in about 120 mL DMF. The reactions were carried out in a microwave reactor at about 150° C. and about 50 bar for about 1 hour. The precipitated yellow powders were purified and activated in a similar manner as the foregoing example. About 250 mg degassed MOF powders mixed with about 500 ul liquid electrolyte, which corresponds to a relative concentration of about 0.5 mg ul⁻¹. The mixture was sonicated for about 5 minutes and aged for overnight, the resulting slurry-like electrolyte shows no trend of phase separations.

Lithium symmetric cells were fabricated using Celgard 3401 microporous polypropylene (PP) membrane for evaluating the interfacial compatibility and lithium transference number. About 12.5 ul of as-prepared slurry electrolyte was uniformly coated on one side of lithium foil, laminated by a PP separator with same diameter, and eventually sandwiched by another identical slurry-coated lithium foil. The symmetric cells were assembled and sealed into CR2032 coin cell configuration under inert atmosphere. A comparative example employs an equivalent amount of liquid electrolyte instead of slurry electrolyte. It should be noted that, concentration of about 0.5 mg ul⁻¹ is selected as a demonstrative purpose, even lower concentration can be achieved with negligible sacrifice on overall energy density while maintaining following superior performances.

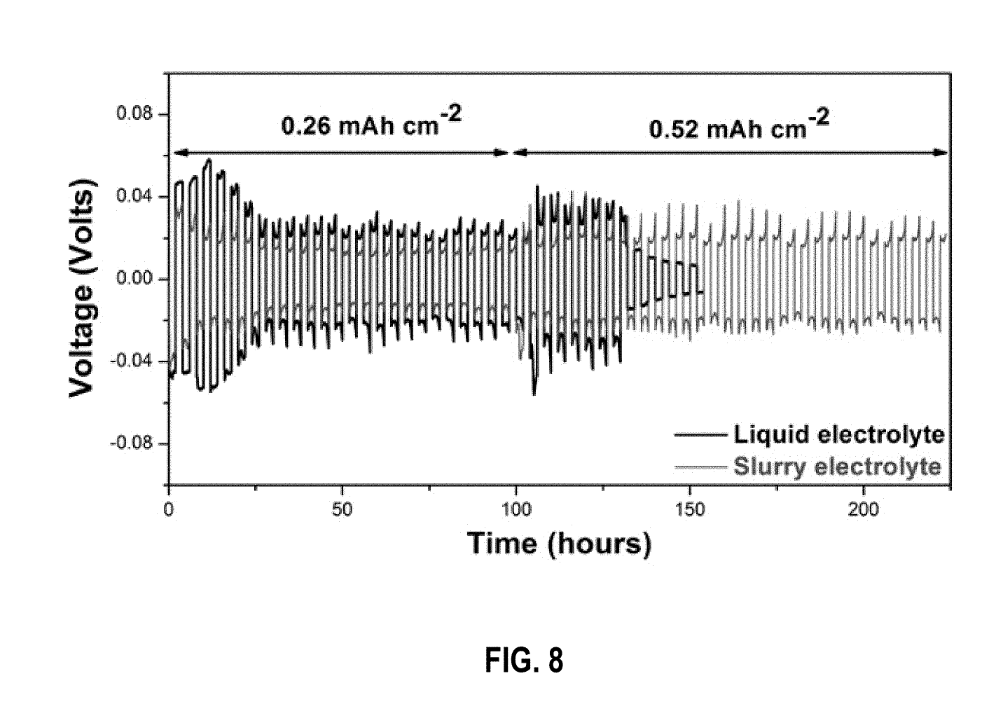

The measurement of the transference number was conducted by referring to the classical Bruce Evans method, which employs a combination of AC impedance and direct circuit (DC) polarization approach. The AC polarization was initially carried out using amplitude of about 20 mV and frequency range from about 1 Mhz to 0.1 hz, the subsequent potentiostatic polarization of about 20 mV was performed for about 30 minutes till the current response along with the time reaching a steady state. Eventually a second AC polarization was conducted to monitor the impedance evolution after the DC polarization. The cell rested for half hour and the whole sets of experiments were repeated. As shown in FIG. 8, the calculated lithium transference number t_{Li}⁺ is as high as about 0.7±0.02, which almost double the lithium transport number as for the liquid electrolyte reported in literature. Whereas the later measurements show that t_{Li}⁺ drops to around 0.5, which might be attributed to an increase of interfacial resistance and thus formation of a new solid-electrolyte interface (SEI).

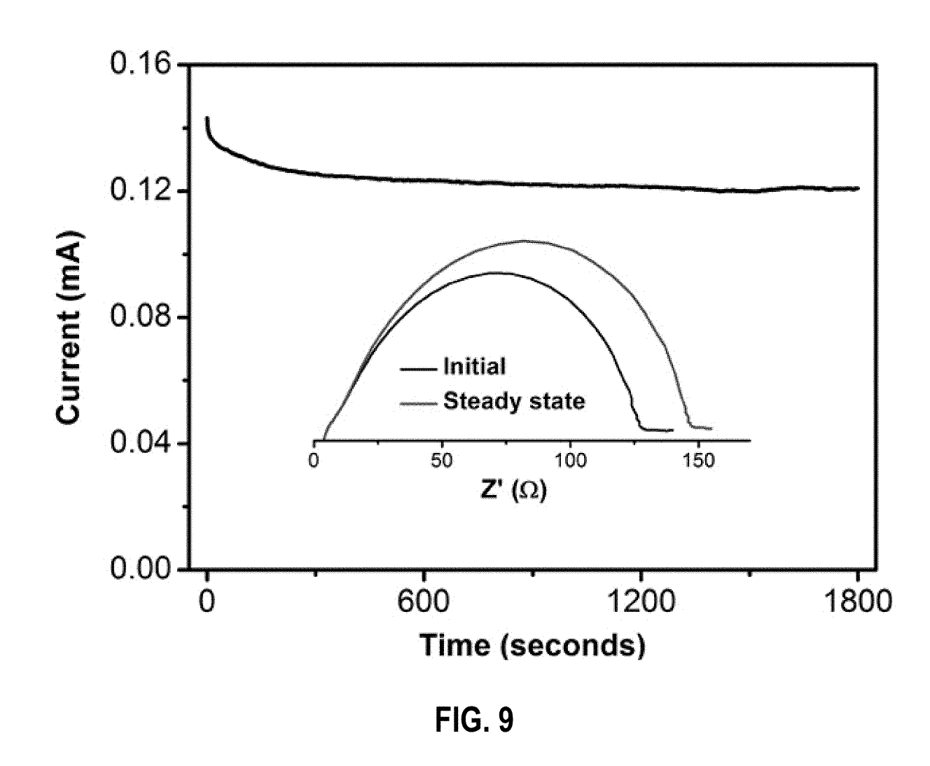

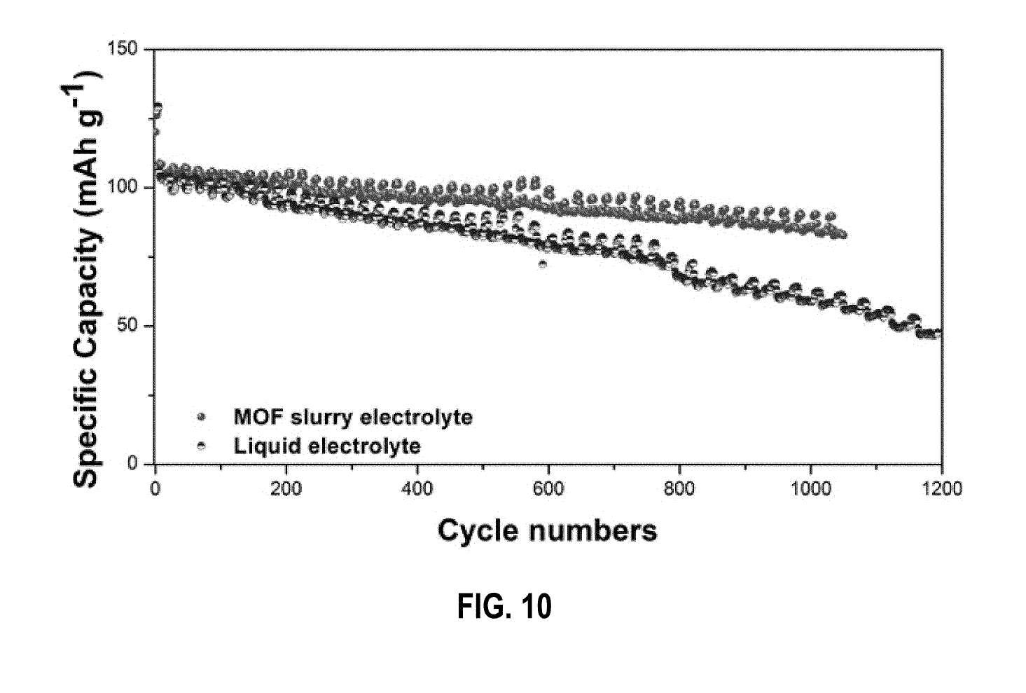

The galvanostatic cycling for symmetric cells was carried out under about 0.13 mA cm⁻² for first 100 hours and about 0.26 mA cm⁻² for the subsequent cycles, as shown in FIG. 9, each lasts for about 2 hours. As compared with the liquid electrolyte, the electrolyte with MOF modulator shows smaller overpotential and reference cell experienced an accidental short circuit within about 150 hours. To conclude, the MOF slurry electrolyte exhibits superior interfacial capability and electrochemical stability than the liquid electrolyte. Furthermore, as shown in FIG. 10, LiFePO₄|Li half cells were fabricated to evaluate the long-term cycling performances at 1C (1C=17 mA g⁻¹). The liquid electrolyte shows capacity decay of about 0.041% per cycle whereas the slurry electrolyte decay is around 0.017% for about 1000 cycles, this could be explained by an enhancement in terms of Coulombic efficiency from about 99.87% to 99.91%. The overall electrochemical performances demonstrate that MOF as electrolyte additive is effective in ameliorating interfacial resistance/stability and reducing parasitic reactions.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrolyte modulator usable for a metal battery, comprising:
a liquid electrolyte; and
a material of metal-organic frameworks (MOFs) incorporated in the liquid electrolyte to form a MOF slurry electrolyte, the MOFs being a class of crystalline porous solids constructed from metal cluster nodes and organic linkers and being capable of bonding anions, eliminating ion pairs and boosting cation transport upon activation and impregnation of the liquid electrolyte.

2. The electrolyte modulator of claim 1, wherein the MOFs have open metal sites (OMS) created by activating pristine MOFs to remove guest molecules or partial ligands thereof.

3. The electrolyte modulator of claim 1, wherein each MOF contains metal centers from the p-block or the d-block, and one or more ligands of benzene-1,3,5-tricarboxylic acid (BTC), benzene-1,4-dicarboxylic acid (BDC), azobenzene-4,4′-dicarboxylic acid (ADC) and isonicotinic acid (IN).

4. The electrolyte modulator of claim 3, wherein the MOFs comprise Cu₃(BTC)₂, Al₃O(OH)(BTC)₂, Fe₃O(OH)(BTC)₂, Mn₃(BDC)₃, (In₃O)(OH)(ADC)₂(IN)₂, or Zirconium-based MOF including UiO-66, UiO-67, UiO-66-NH₂, UiO-66-OH, or UiO-66-Br.

5. The electrolyte modulator of claim 1, wherein the liquid electrolyte comprises one or more non-aqueous solvents and metal salts dissolved in the one or more non-aqueous solvents,
wherein the one or more non-aqueous solvents are selected to match the surface properties of the MOF material; and
wherein the metal salts are selected to have anions with desired sizes, which depends, at least in part, upon the MOF material, wherein the anion sizes are selected to ensure that the salts to infiltrate into at least some of the pores of the MOFs, and then become immobilized therein to form the ionic conducting channels.

6. The electrolyte modulator of claim 5, wherein the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

7. The electrolyte modulator of claim 5, wherein the metal salts comprise one or more of a lithium (Li) salt, a sodium (Na) salt, a magnesium (Mg) salt, and a zinc (Zn) salt,
wherein the lithium salt includes lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, or a combination thereof;
wherein the sodium salt includes sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), or a combination thereof;
wherein the Mg salt includes magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), or a combination thereof and
wherein the Zn salt includes zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), or a combination thereof.

8. The electrolyte modulator of claim 1, wherein a weight ratio of the MOFs to the liquid electrolyte ranges from about 10:1 to about 1:1000.

9. A battery, comprising:
the electrolyte modulator of claim 1;
a positive electrode; and
a negative electrode,
wherein the electrolyte modulator comprises the MOF slurry electrolyte disposed between the positive electrode and the negative electrode.

10. The battery of claim 9, wherein the battery is a lithium (Li) battery, a sodium (Na) battery, a magnesium (Mg) battery, or a zinc (Zn) battery,
wherein the positive electrode of the Li battery includes at least one of LiCoO₂ (LCO), LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide, lithium vanadium oxide (LiV₂O₅), Li₂MSiO₄ wherein M is composed of any ratio of Co, Fe, and/or Mn, and a material that undergoes lithium insertion and deinsertion;
wherein the positive electrode of the Na battery includes at least one of NaMnO₂, NaFePO₄, and Na₃V₂(PO₄)₃;
wherein the positive electrode of the Mg battery includes at least one of TiSe₂, MgFePO₄F, MgCo₂O₄, and V₂O₅;
wherein the positive electrode of the Zn battery includes at least one of γ-MnO₂, ZnMn₂O₄, and ZnMnO₂;
wherein the negative electrode of the Li battery includes at least one of Li metal, graphite, hard or soft carbon, graphene, carbon nanotubes, titanium oxide, silicon (Si), tin (Sn), germanium (Ge), silicon monoxide (SiO), silicon oxide (SiO₂), tin oxide (SnO₂), transition metal oxide, and a material that undergoes intercalation, conversion or alloying reactions with lithium; and
wherein the negative electrodes of the Na, Mg and Zn batteries include Na metal, Mg metal, and Zn metal, respectively.

11. The battery of claim 9, wherein some or all the electrode materials are combined with the MOF slurry electrolyte to achieve better ion transport throughout the electrode layers.

12. The battery of claim 9, further at least one electron blocking separator membrane disposed in the the MOF slurry electrolyte between the between the positive electrode and the negative electrode.

13. The battery of claim 12, wherein the at least one electron blocking separator membrane is either ionic conductive or non-conductive.

14. The battery of claim 12, wherein the at least one electron blocking separator membrane comprises poly-propylene (PP), poly-ethylene (PE), glass fiber (GF), polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, copolymers thereof, perovskite lithium lanthanum titanate Li₃ₓLa_{(2/3-x)}M_{(1/3)-2x}TiO₃, wherein 0<x<0.16, and M=Mg, Al, Mn, Ru, or the like, lithium phosphorous oxynitride (LiPON, Li_{3.5}PO₃N₀₀₅), garnet oxide including Li₅La₃M₂O₁₂, wherein M=Nb, Ta, or Zr, lithium sulphide, or combinations thereof.

15. A method for making an electrolyte modulator for a battery, comprising:
incorporating a material of metal-organic frameworks (MOFs) into a liquid electrolyte to form a MOF slurry electrolyte, the MOFs being a class of crystalline porous solids constructed from metal cluster nodes and organic linkers and being capable of bonding anions, eliminating ion pairs and boosting cation transport upon activation and impregnation of the liquid electrolyte.

16. The method of claim 12, further comprising synthesizing the MOF material based on a facile hydrothermal method, or without a water modulator.

17. The method of claim 12, further comprising creating open metal sites (OMS) of the MOFs by activating pristine MOFs to remove guest molecules or partial ligands thereof.
